(19) United States
(12) Patent Application Publication
(10) Pub. No.: US 2007/0022632 A1
(43) Pub. Date: Feb. 1, 2007

(54) Massaging footbed having sole with pattern of waves and method of making same

(76) Inventor: Chung Hsiung Lan, Guang Dong (CN)

Correspondence Address: M.H. Sears Law Firm Chartered;Suite 800, 910 Seventeenth Street, NW, Washington, DC, 20006, US

(21) Appl. No.: 11/191,927

(22) Filed: Jul. 29, 2005

(51) Int. Cl. A43B 13/38; A43B 23/00; B29C 44/02

(52) U.S. Cl. 36/43; 264/51

(57) ABSTRACT

Footbeds that are deformable, resilient, capable of exerting a massaging effect on the human foot sole and useful in various kinds of footwear have an upper sole configurated in the form of a continuous pattern of undulating waves produced by the action of a machine that is constructed with (a) two identical rollers positioned one above the other and each covered with closely spaced, evenly aligned, rounded steel protrusions extending around its entire periphery, said rollers being adapted to rotate in countercurrent directions to move a foamed plastic mass of EVA polymer forward from a point at which said mass is fed between them and (b) knife means positioned just behind and between the two rollers, which knife means acts to rapidly slice longitudinally into two separate sheets each plastic mass immediately as it begins emerging from between the rollers. The combined action of the counter currently rotating rollers exerts a pressure in order of about 1200 kg per sq. cm. on the plastic mass as it is moved between them. Of the two sheets of EVA plastic foam that emerge from the knife means the upper one has the waves pattern on its bottom side and the lower has the waves pattern on its upper side. The sheets are allowed to rest and conventionally cut into matching sized pairs of footbeds.

### FIELD OF THE INVENTION

The present invention relates to articles of footwear having a deformable resilient sole which contacts the bottom of the wearer's foot, which sole is configured in the shape of undulating “waves” as hereinafter described and defined, which in combination with the sole's resilience, exert a soothing gentle, massaging effect on the sole of the wearer's foot.

### BACKGROUND OF THE INVENTION

Numerous articles of footwear have been described which have soles designed to exert a massaging effect on the bottom of the wearer's foot, thereby stimulating blood circulation throughout the wearer's body, minimizing shocks to the foot from exterior sources and generally contributing to the overall comfort and health of the wearer.

Many of these articles are said to provide benefits to the overall health of the body in accordance with various principles of Oriental medicine, particularly those of acupuncture.

Others stress the principles of Western reflexology, a subject which is now recognized to have some areas in common with Oriental medical principles apposite to the foot.

Numerous modes of achieving continuous massage in at least some regions of the foot have been proposed. For example, Birkenstock U.S. Pat. No. 3,722,113 issued Mar. 27, 1973; Nakamoto U.S. Pat. No. 3,859,727 issued Jan. 14, 1975; Foldes U.S. Pat. No. 4,095,353 issued Jun. 20, 1978, and Goller U.S. Pat. No. 4,674,703 issued Jun. 23, 1987 exemplify various footwear soles that are wholly covered with rows of tiny projections or “lugs” said to accomplish continuous foot massage. Some prior art soles of this type include ventilation means for delivering air to the wearer's foot while it is being continuously massaged by tiny projections, including Goller U.S. Pat. No. 4,674,603 mentioned above, Daswick U.S. Pat. No. 4,345,387 issued Aug. 24, 1982, Tsai U.S. Pat. No. 4,831,749 issued May 23, 1989 (combining massaging “beads” with air holes), and Goller U.S. Pat. No. 4,910,882 issued Mar. 27, 1990 (combining a series of continuous ribs running transverse to the generally longitudinal orientation of the sole with air-supplying grooves between the ribs). Still other known footwear soles involve projections located in selected portions of the footwear sole for providing massage at established pressure points of the foot—see, e.g. Seltzer U.S. Pat. No. 4,694,831 issued Sep. 22, 1987 and Buchsebschuss U.S. Pat. No. 5,664,342 issued Sep. 9, 1997.

Another embodiment of footwear falling within this broad category is disclosed in U.S. Pat. No. 5,287,638 issued Feb. 22, 1994 to Preston wherein a midsole water massage chamber for massaging the foot is located beneath an insole and the shoe is equipped with a shock absorber in the heel area. Still other embodiments of footwear said to produce a massaging effect are disclosed in Chang U.S. Pat. No. 5,682,690 issued Nov. 4, 1997 which depends on a number of spring-loaded rods located in the footwear sole to massage the foot and Reilly U.S. Pat. No. 5,836,899 issued Nov. 17, 1998 wherein massage of the foot is effected by a battery operated power supply mounted in the tongue of a shoe which activates vibrators mounted in the sole of the shoe, Crane et al U.S. Pat. No. 6,598,321 issued Jul. 29, 2003 describes a “shock-absorbing” athletic shoe with a removable insole which is equipped with inserts containing a viscoelastic gel material which may be used alone or in combination with a number of transversely positioned thin spring walls of various configurations (see FIG. 4-16) to provide comfort to the foot and prolong the ability of the wearer to walk over extended periods of time, due to improved shock absorbency and cushioning energy afforded the foot. U.S. Pat. No. 6,675,500 to Codamurs issued Jan. 13, 2004 discloses another form of athletic shoe equipped with a multiplicity of shock-absorbency springs embedded in the sole of the shoe beneath the wearer's foot which produce a damped aperiodic motion as the foot moves in walking or running.

These prior footwear sole embodiments each produce some form of foot massage when worn. However, many of them are uncomfortable, unwieldy, and overly heavy or cumbersome to wear for extended time periods. Some are unsightly and unsuited to general everyday wear in normal environments. Others, even while affording impact cushioning or continuous foot massage are not comfortable for any type of wear that exceeds an hour or two at a time. Moreover, most of the items referred to above have soles to be contacted with the sole of the human foot that, while in some instances said to be incorporatable in conventional everyday shoes, are unsuited to that purpose for a variety of reasons.

It is to be understood that machinery potentially capable, if equipped with the rollers described and depicted herein, of transforming foamed plastic into a “wavelike” configuration such as described hereinafter has been available in at least Taiwan and China, and perhaps elsewhere, prior to the present invention. Such machinery, however, has been equipped only with smooth surfaced steel rollers and has therefore been able to produce only flat sheets of plastic foam. The finished foamed sheets produced in these machines have been used in the manufacture of pillows, mattresses and related items, such as inserts for sofas and chairs. These foamed sheets, however, have essentially smooth surfaces on both sides because the rollers used in the machines have essentially smooth surfaces, unlike the rollers that produce the “waves” of the footbeds disclosed herein. Formulations of plastic foam used in pillows, mattresses, and the like are also different from the foam formulation disclosed herein and found by the applicant to be optimum for resilient shoe sole compositions.

### BRIEF DESCRIPTION OF THE INVENTION

The present invention resides in a deformable resilient footbed with an upper surface criss-crossed by a gentle, undulating pattern resembling that of the waves of the sea in a period of relative calmness. This footbed may be used in almost any type of footwear to be worn by men, women or children. Its wavelike upper surface, referred to hereinafter as the “waves”, produces a massaging effect upon the wearer's footsole in the course of being alternately compressed and released as the wearer walks or otherwise engages in activity in which the foot is alternately flexed and relaxed. The massaging effect experienced on the soles of the wearer is attributable to the combined (1) configuration and (2) composition of the “waves” footbed. This footbed consists essentially of ethylene vinyl acetate (“EVA”) polymer foam, prepared according to the formula set forth under “Detailed Description of the Invention” hereinafter.

The EVA foam is prepared in batches of about 75,000 grams each. Each batch is fed to a blow-molding machine that produces very thin, generally rectangular sheets of EVA foam. These sheets are then passed into a forming machine maintained at a temperature of 170 to 180 E C. and a pressure of at least about 800 kg. per square cm. wherein each thin sheet foams and hence “grows” substantially larger in all its dimensions.

The foamed pieces obtained from the forming machine are in general, much thicker, in the order of at least 15 or 20 times the thickness of the thin sheets produced in the blow molding machine, and commensurately increased in their length and width dimensions. They are also extremely hot and are immediately set aside to air cool enough so that they can be handled by humans.

These pieces are then cut into rectangular slabs each of which has a width roughly ⅓ of the length of each the two customized rollers of the planer machine, a thickness adapted to be fed between the rollers of approximately 55-65 cm. and a length of about one-half meter. These dimensions are approximations, and are in no sense critical. In general, they are based on practical experience in working with the planer machine, which is fed by hand and downloaded by hand, and is closely supervised by an experienced operator whenever it is in operation. The width dimension of the plastic slab, for example, is essentially doubled by the action of the rollers, as can be seen by comparing FIGS. 3 and 4 hereof which are, respectively a view of a slab being fed to rollers of the planer machine and a view of the same slab, emerging from the joint cooperative effects of the rollers and the knife (or cutter), which slices the slab longitudinally into two sheets at the moment it commences emerging from between them and continues to do so until the slab completes its travel between the rollers and has been wholly converted into two, essentially mirror-image, sheets.

Each thick rectangular slab is hand fed to the roll guide of the two heated customized rollers of the planer machine which are each moving at the same speed but in countercurrent directions i.e., the upper one moves in counterclockwise direction, while the lower one moves in a clockwise direction. The slab is guided between the two rollers which, in part, coact to move it forward between them so that it passes on, outside their zone of influence. The rollers have identical steel surfaces with closely spaced, evenly aligned rows of rounded protrusions extending around their peripheries. The rollers, both of which remain in continuous contact with the moving slab as it passes through them, compress the slab from above and below it, in concert exerting a pressure of about 1200 kilograms per square centimeter on the slab; the rounded, protrusions on the rollers simultaneously exert an elastic deforming action on the interior of the foamed plastic slab, creating internal voids and adjacent external areas of concentrated plastic foam in the middle thickness, or core, of the slab. Midway between the rollers and at the point of emergence of the slab from contact with both rollers, a horizontally disposed sharp knife mounted on a continuously moving belt slices instantaneously into the slab at the midpoint of its thickness dimension, thus arresting the roller-caused inner deformation of the slab's core portion before the elastically deformed foamed plastic in that area can relax sufficiently to return to the physical condition in which it was before the slab was fed between the rollers. The action of the knife produces two EVA foam plastic sheets, each one-half as thick as the slab, the upper one of which exhibits the “waves” on its lower surface and the lower one of which exhibits that pattern on its upper surface. The emergent wave-patterned sheets of plastic each have a thickness ranging between about 10 centimeters in the thinnest parts of the “waves” pattern and about 30 centimeters in the thickest portions of the “waves” pattern.

The two sheets are allowed to rest and then are placed with their smooth sides facing one another in another machine which cuts out the two footbeds needed for a pair of footwear of any desired size by slicing downward with a cutter form (selected from among a complete inventory of sized forms) through both of the plastic foam sheets. The result in each instance is a pair of same sized footbeds, each of which has a flat bottom side that can be affixed, e.g., to a pair of standard bottom sole pieces of the same size in due course and an upper side exhibiting the “waves” which may be finished by coating it with a liquid resinous coating and drying the coating. The footbeds may be sold, in this finished form, to footwear manufacturers or they may be directly converted into footwear and then sold.

The details of the finishing of the footbeds depend upon the type of footwear in which they are to be used.

A presently preferred use of the footbeds is in sandals for men, women, and children, wherein each footbed is dipped into a liquid coating of pigmented resinous material for a few seconds to coat it and then subjected to a drying process followed by equipping the top side of the footbed on which the “waves” pattern appears with straps, thongs, a band covering the toe portion or any other type of decorative or utile fitting designed to aid in holding the sandal on the wearer's foot. Various techniques for attaching whatever fittings are selected to a sandal's sole in a stable and reliably permanent way are well known in the art.

When, in the process of converting the footbed to a finished sandal, it has been dipped into a pigmented resinous liquid coating and thereby coated, immediate drying of the coating is the necessary next step. Many drying techniques and types of driers are available and can be used, as desired. The footbeds are suitable for incorporation in many types of footwear other than sandals, including boots, slippers and a variety of both general purpose and specialty shoes. The massaging effect on the sole of the human foot that is achieved by the combined action of the “waves” configuration and the EVA foam composition on the sole of the human foot is particularly beneficial when incorporated in footwear to be worn for walking or prolonged standing on one's feet.

### BRIEF DESCRIPTION OF THE DRAWINGS

FIG. 1A is a photograph of a finished sandal containing a “waves” footbed, as viewed from above and to one side of the sandal. The sandal is equipped with a front member, shaped to fit the front of a human foot and consisting of an inner piece of dark-colored fabric which is slightly larger than the corresponding outer piece of light-colored fabric so that the two have been seamed together in a way that permits the dark fabric to appear as a piped edging for the light-colored fabric when the sandal is being worn.

FIG. 1B is a photograph of a pair of finished sandals, each equipped with a footbed of this invention, to each of which a thong adapted to fit between the large toe and the immediately adjacent toe of a human foot has been added. The thong is attached to and held up by a tubular strap adapted to encircle all but the heel portion of the foot and aid in keeping the sandal on the foot while it is being worn.

FIG. 1C is a drawing of the side view of a sandal similar to those in the pair depicted in FIG. 1B, in that the footbed of this invention is similarly equipped with a thong fastened to the sole through a hole made in the footbed and also held up by a strap fastened to the sole on either side of the foot at a point in front of the wearer's heel so that this strap encircles the foot, except for the heel, when the sandal is being worn. The side view drawing clearly shows the appearance of the “waves” pattern of the footbed.

FIG. 2 is a sketch of the planer machine, the operation of which produces the “waves” on sheets of EVA plastic foam.

FIG. 3 is a photograph of a foamed EVA plastic foam slab being hand fed between the two steel rollers of the planer machine by an operator.

FIG. 4 is a photograph of two sheets made by immediate longitudinal splitting of a slab of EVA foam by the belt knife (or “cutter”) as it emerges from between the rollers. The “waves” pattern is highly visible on the top of the lower sheet but less easy to discern on the bottom of the upper sheet due to the angle of the photograph and a slight blurring of the photograph in that area.

FIG. 5 is a sketch of two sheets of EVA plastic foam as each appears after emergence of the slab from between the rollers of the planer and the slab's virtually simultaneous lengthwise splitting into two sheets by the belt knife. In the sketch, the sheets are depicted in the same spatial relationship to one another as they are in the photograph that is in FIG. 4, but without the presence of machine parts.

FIG. 6 is a photograph of the upper side of one finished “wave” sheet which has been cut by two different sized foot forms. What cannot be seen in the photograph is that (a) the lower flat side of the sheet abuts the flat side of a corresponding sheet also obtained by longitudinal splitting of a single plastic slab as the slab emerged from between the rollers of the planer machine, (b) that the lower sheet on its lower side bears the “waves” pattern and (c) both sheets were simultaneously cut through by the same two, different sized, sharp edged, metal foot forms so that two pairs of footbeds in different sizes are present.

### DETAILED DESCRIPTION OF THE INVENTION

As previously stated, the massaging effect that the footbeds of this invention exert on the feet of a wearer is the result of the combined interaction on the wearer=s feet of the “waves” pattern and the EVA plastic foam composition of which the footbeds are composed.

In arriving at this invention, the applicant herein tested a great variety of plastic foam compositions and tried many experimental types of customized roller surfaces on the planer machine over a period of approximately eight years. Many combinations of plastic foam composition and upper sole configuration (as produced by action of earlier forms of experimental rollers on plastic slabs) produced in these experiments were unsightly or produced uncomfortable sensations on the sole of a human foot. Many such combinations were insufficiently resilient; others were too resilient. All the various prior combinations of foamed plastic composition with upper sole configuration that were tried prior to the combination disclosed herein, failed to produce the desired effect on the sole of the human foot of a continuous gentle massage as the foot is alternately compressed and released during the action of walking and other actions which flex or bend the foot sufficiently to alternately compress and release the footbed sole.

The EVA foam formulation which is an integral part of this invention is, as mentioned above, usually prepared in batches of about 75,000 grams total weight. The recipe for such a batch consists of

| | | |
|---|---|---|
| ethylene vinyl acetate polymer | 43,400 | grams |
| zinc oxide | 800 | grams |
| stearic acid | 300 | grams |
| dicumyl peroxide | 500 | grams |
| calcium carbonate | 23,000 | grams |
| azodicarbonamide | 6,000 | grams |
| color pigment | 1,000 | grams |

In this recipe, the color pigment is normally white, albeit any other color could be substituted if desired.

These ingredients are weighed out, in the specified quantities, and the mixture is placed in a 100 gallon drum or other similar sized receptacle equipped with an industrial size stirrer. The mixture is stirred with the stirrer for 20-30 minutes at ambient temperature and thereafter it is fed to a conventional blow molding machine which molds the EVA foam mixture into a series of very thin sheets of generally rectangular shape.

The sheets so produced are next fed into a forming machine maintained at a temperature of 170°-180° C. and a pressure of at least about 800 kg. per square cm., where the EVA sheets foam and expand greatly in all dimensions.

It is emphasized that the blow molding step and the forming step could be replaced by any other treatment that would result in producing highly foamed EVA plastic pieces. These pieces, upon emergence from the forming machine, are extremely hot and are set aside and permitted to air cool. Many of them are too large, as explained above, to be handled in the planer machine and so they are cut into slabs sized for easy human handling, that are selected to permit their passage between the custom-made rollers of the planer machine and their compression by these rollers into a larger sheet.

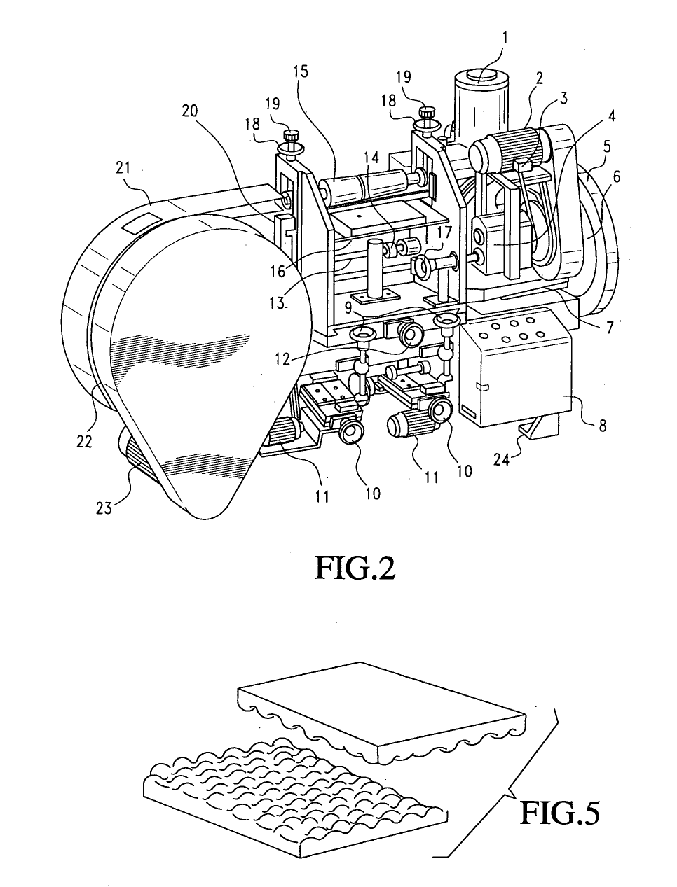

FIG. 2 is a sketch of the planer machine wherein its visible parts are numbered and designated by a line extending from each number to the corresponding part that the number represents. The sketch, which is FIG. 2, was made from the side of the machine on which EVA plastic slabs are hand fed between the two customized, upper and lower rollers of the machine.

In the sketch, FIG. 2 hereof, the part labelled as 1 constitutes a wash bucket which the machine operator from time to time fills with water. The water is delivered, as needed, to the belt knife to cool it down from the high temperature imparted to it when the wheel on which it rests is running rapidly and causing the knife, to slice longitudinally through the midsection, or “core,” of slabs of EVA plastic foam emerging from between the rollers. It is important that the knife not be allowed to overheat, because this may impair its ability to slice rapidly and sharply through the hot foamed plastic slab.

The part labelled as “2” is a motor which supplies power to the customized rollers so that they are able to rotate in countercurrent directions, while at the same time causing the slab to move rapidly through them. The total transit time of the slab, from its introduction by the machine operator to the roll guide that feeds it between the rollers until its emergence from between the rollers and the immediate longitudinal slicing of it into two sheets by the machine operated belt knife, is approximately 10 seconds.

Numbered part 3 is called a “reducer bar”; it is the operational control member for part 4, the “reducer,” which is actually a gear that is operated by part 3 to control the speed of the wheel on which the belt knife runs. Numbered parts 5 and 21 are “side cover” parts, the purpose of which is to protect the human machine operator from the potentially dangerous fast moving wheel carrying the belt knife.

Part number 7 indicates the dock (or “block”) which supports the weight of most of the planer machine.

Part number 8 is a switch box containing control buttons for switching on and off (a) the power for the motor 23 that controls the supply of power delivered to the rollers, (b) the power for the motor that controls the belt knife 20 and the wheel (not visible in FIG. 2) on which it travels and (c) the motor that controls the knife sharpener (also known as the “knife grinder”). Switch box 8 also contains an emergency button which, if pushed, as in an emergency, stops all activities of the planer machine.

The part numbered 9 is a hand operated wheel by which the machine operator is able to adjust the distance between the belt knife and its sharpener. Part 10 is a further hand adjusting wheel which determines the degree of contact between the belt knife and its sharpener, while part 11, the stand wheel motor supplies the power that enables the knife sharpener to contact the belt knife and sharpen the knife. The machine operator's operation of the adjusting wheels 9 and 10, and his coordination of the adjustments, allows these wheels to cooperate in effecting the frequent sharpening of the belt knife that the power from motor 11 makes possible. Keeping the knife very sharp is extremely important to maintaining a consistent precision and quality level in the rapid splitting by the knife of the plastic slab at the midpoint of that slab's thickness, since it is only in the middle core portion of the slab that the rollers create the pressure conditions essential to the formation of the “waves” pattern on the sheets.

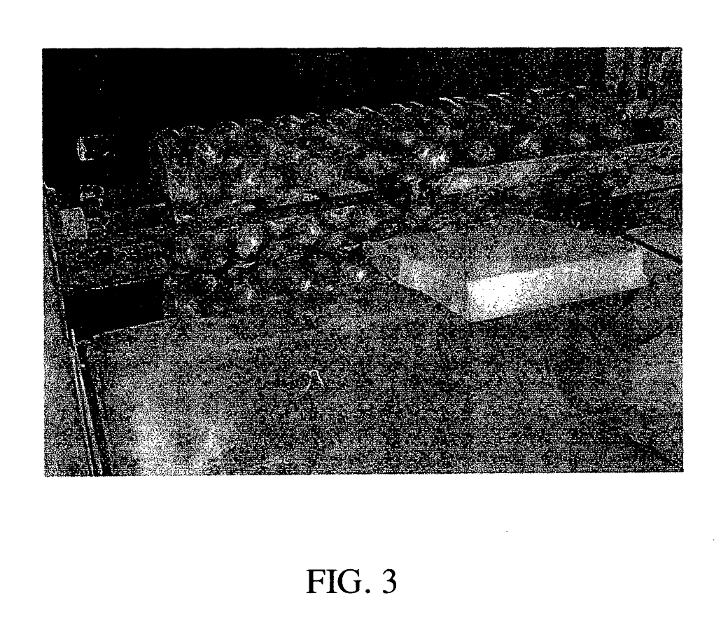

Part number 12 is another adjusting hand wheel which is used to raise or lower the height of the “feeding platform” part numbered 16, on which the slab is rested as it is fed by the machine operator, with the help of the roll guide, between the rollers. FIG. 3 hereof is a photograph of an EVA slab being thus hand fed between the rollers from the feeding platform by the machine operator.

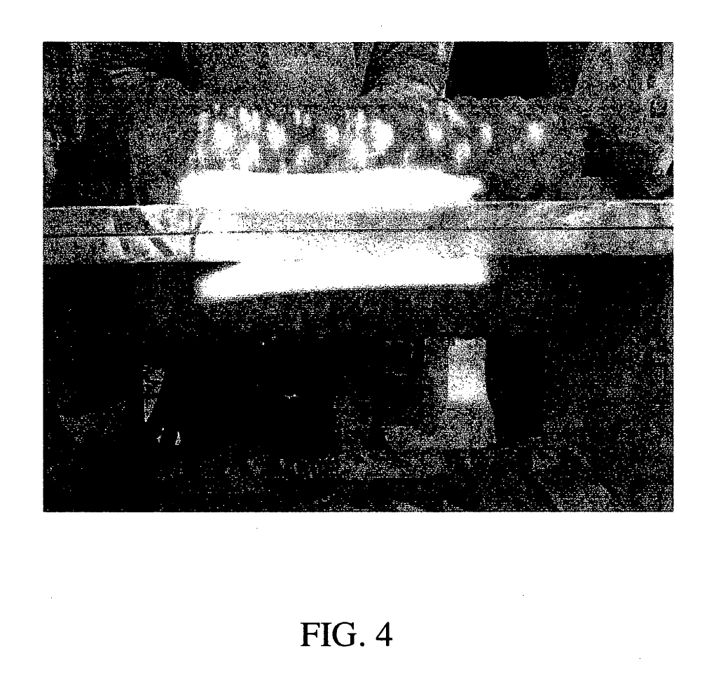

Part No. 13 is a transmitting screw which can be used to adjust the distance between the platform 16 and the belt knife by moving the platform up or down. Part No. 14 is a clutch which is used by the machine operator to assist in slowing down or speeding up the activity of the planer machine as needed. The part numbered 15 is the upper of the two rollers which receive the EVA foam slab between them and push it forward between them while also simultaneously squeezing and compressing it and acting on its middle core region to produce alternate voids and concentrations of plastic material in that core region. These rollers roll the slab out and directly into the path of the belt knife 20 which splits the slab longitudinally into two sheets of roughly equal thickness. As already noted herein, the rollers move countercurrently to each other, the upper one in a counterclockwise mode and the lower one in a clockwise mode. The surfaces of the two rollers are covered with rounded protuberances arranged in rows, as can readily be seen in FIGS. 3 and 4 which are both photographs taken during actual operation of the planer machine on a slab of EVA foam. FIGS. 3 and 4 clearly show the structure and arrangement of the rounded protuberances that cover the periphery of each roller. These protuberances play a crucial part in the interior elastic deformation of the slab as it moves between the two rollers, which interior elastic deformation is crucial to the formation of the “waves” that takes place as the belt knife acts immediately and rapidly to split that core portion longitudinally and thereby immediately arrest the natural tendency of the slab's core portion to revert to a non-elastically deformed, essentially flat, state.

Parts 17 and 18 are each hand wheels which the machine operator adjusts as needed. Part 17 is used to adjust the height between the lower feeding roll and the belt knife, while Part 18 is used to adjust the height between the belt knife and the upper feeding roll.

Part 20 is the belt knife itself and Part 23 is the knife motor which supplies power to the large circular wheel to which the belt knife is fastened and by which it is caused to move through (and slice into two parts) the EVA foam slab.

The two parts labeled as 19 and 24 indicate bolts which can be tightened or loosened by the operator as circumstances dictate. They are of particular importance when the machine is being cleaned or needs to be repaired.

The lower feed roller and the knife sharpener are two of several important parts of this machine that cannot be seen on the side of the planer machine on which the sketch, FIG. 2, was made. For the lower roller, this is compensated by its being clearly visible in the two photographs, FIGS. 3 and 4 which respectively show the EVA foam slab (FIG. 3) being fed between the rollers and the slab emerging split into two sheets by the knife means positioned immediately after the rollers and exhibiting “waves” clearly on top of the bottom sheet and albeit less distinctly, also exhibiting “waves” on the bottom of the top sheet (FIG. 4).

As explained earlier, the countercurrent forwarding of the slab by the counterclockwise moving top roller and the clockwise moving lower roller, acting in concert, strongly squeezes and compresses the EVA foam plastic slab, exerting a pressure of about 1200 kg per sq. cm. on the moving plastic slab, and subjects both sides of it in doing so to the special opposing action of the rounded, evenly spaced protuberances that cover both rollers, whereby the interior middle core portion of the moving slab is elastically deformed, and alternating voids and areas of concentrated plastic foam form in the slab's middle core.

The immediate slicing action of the sharp knife arrests this interior elastic deformation of the EVA plastic foam before the plastic foam can revert to its previous, even, relaxed state, with the result that the sliced slab yields an upper sheet with “waves” on its under side and a lower sheet with “waves” on its upper side. In the past, attempts to produce a similar result by substituting other types of foamed plastic slabs for the herein described EVA foamed plastic slab, have been unavailing. When such other foamed plastic slabs were fed between the specially designed and constructed rollers of the planer machine as herein described, operating in countercurrent rotation to pass each such slab immediately to the herein described sharp knife which sliced the slab, in each instance, into two sheets, it was found that the pattern achieved regularly and in highly reproducible fashion with EVA foam plastic slabs could not be attained.

After removal from the planer and being allowed to rest, the two EVA foam plastic sheets, each having the “waves” configuration on its side that faces the other sheet, are placed together in obverse fashion with their flat sides abutting one another and are then moved into another machine, which is of a type that is common in the footwear industry wherein the soles of footwear of varying sizes (and hence of varying lengths and widths) are cut out. In this machine the footbeds of this invention are cut out.

FIG. 5 hereof is a sketch of two EVA foam sheets obtained from an EVA foam slab, which slab after passing through the rollers of the planer machine, was sliced through longitudinally by the belt knife as the slab emerged from the rollers. FIG. 5 demonstrates the appearance of these upper and lower sheets as they appear relative to one another upon being removed from the planer machine, with the “waves” pattern appearing on the bottom of the upper sheet and on the top of the lower sheet.

In the present instance, it has been recognized that when the two sheets are placed in contact with their respective flat faces abutting one another, and a “waves” configurated face is then on top of this stack of two layers, with another “wave” configurated face on the bottom of the stack, a right (or a left) foot-shaped cutter of each desired size can be placed on the top and can be caused, by any suitable mechanical means, to cut through both thicknesses of plastic, thereby producing, in each instance, a pair of footbed sole portions, a right one from the uppermost sheet and a left one from the lowermost sheet or vice versa. Each member of the footbed pair thus cut out has a “waves” pattern on its sole portion that will contact one of the wearer's feet and a flat portion that can optionally be finished by conventionally adhering to it a thin, suitable undersole of rubber or any other appropriate material.

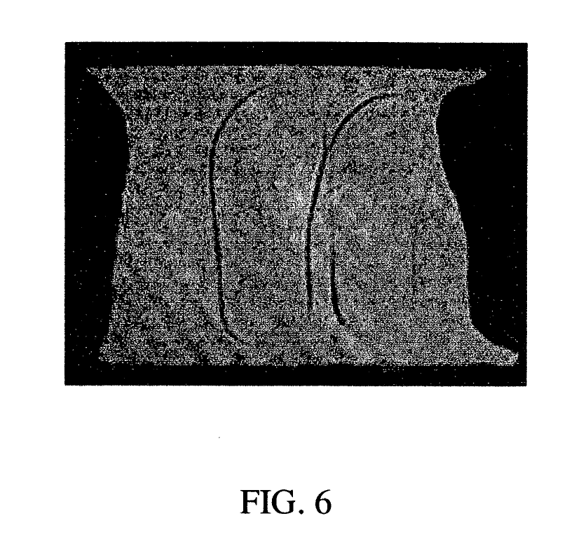

FIG. 6 hereof depicts the upper side of such a two-layer combination of two EVA foam sheets, each bearing one side configurated in the “waves” pattern. In FIG. 6, the outlines of two left footbeds of different sizes appear, which have been sliced through by sharp edged cutting frames of the respective sizes. The “waves” pattern can be seen on the entirety of the visible surface of the top EVA foam sheet, including the surfaces of the two cut out, but not yet removed, footbeds.

As noted earlier, the major use currently being made of the footbeds herein described is as the major component of various styles of sandals for men, women, and children. In order to make such sandals, the footbeds that have been cut out from the EVA sheets obtained from the planer machine as just described, in a type of machine well known among shoe manufacturers, are forwarded to an area where they are coated, preferably by dipping each footbed for a few seconds into a liquid resin-based coating composition, followed by a drying step.

Instead of by dipping, the coating composition can also be applied to the footbeds by spraying or in any other effective manner. To dry the coated footbeds, any drying process found to be effective may be used. Applicant has found it both convenient and effective to place the dipped, coated footbeds on a conveyor belt that carries them under seven different radiant heaters from various manufacturers that are operated at a temperature known to be needed for the drying of the resinous coating composition. This drying results in a smooth, glossy finished coating, having a very attractive appearance.

The coating composition used for the sandals may be any known resin-based liquid coating composition suitable for coating a foamed plastic composition. Many such compositions exist, and many of them are capable of producing a smooth, glossy, finish on a sandal made from the EVA foam composition herein disclosed.

The sandals made with the footbeds of this invention may be finished by affixing to their lower flat surface relatively thin flat undersoles of any type whether nonslip, waterproof, or any other type suitable for contacting the various surfaces on which humans are known to walk.

If desired, the footbed of this invention can be used in making a wedge-type of sandal by constructing an undersole for the footbed of the “wedge” type. Techniques for such construction are well-known in the art and any of them may be availed of for this purpose. When such a wedge sole is to be added to a footbed of this invention, it is desirable to affix it to the flat underside of the footbed prior to coating the footbed, in order to enable the added “wedge” to be coated in exactly the same manner and have same finished appearance as the footbed itself.

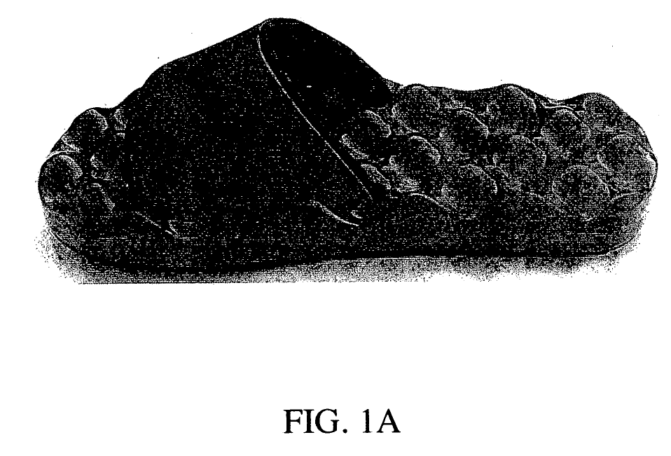

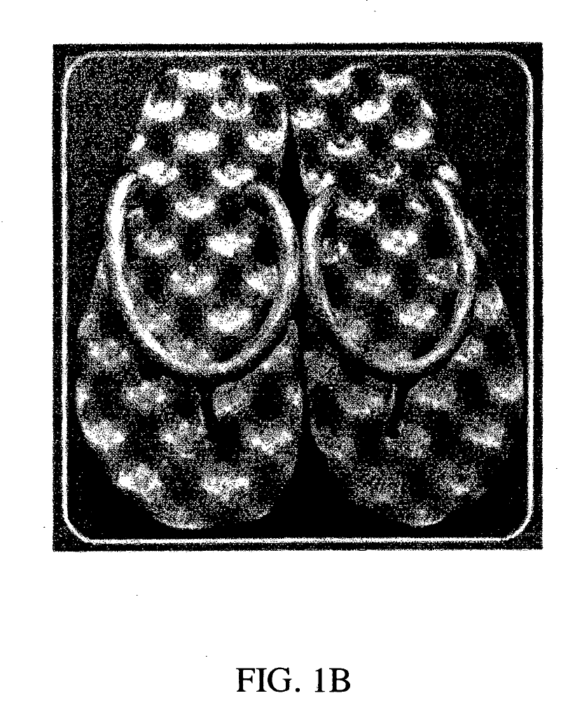

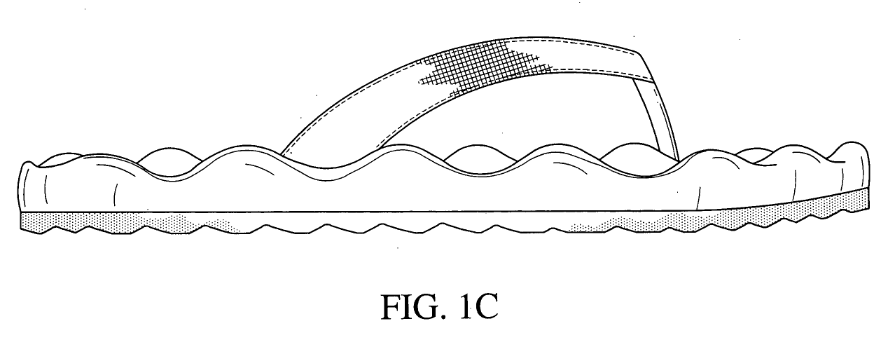

The upper portion of the sandal likewise may be of any style that is adequate to insure that the sandal will stay securely on the foot during normal wear and may include straps of various types, which may be tied, buckled, or fastened in any other manner, or may consist of a front band similar to that shown in FIG. 1A, which may be made from fabric, leather, straw, plastic, or any other suitable material. Techniques for fastening various kinds of attachments to an upper sole are well known and need not be detailed here. They are normally effected, for sandals based on the finished, coated and dried footbed, before the addition thereto of an undersole piece.

As earlier stated herein, it is contemplated that footbeds of this invention will be used in a wide array of diverse forms of footwear other than sandals and particularly in boots, athletic shoes of varying types, walking shoes and slippers.

Many minor modifications and alterations in the invention as herein disclosed will readily occur to others skilled in at least one of either or both of footwear manufacture and manufacture of foamed plastic items. It is accordingly hereby stated that the invention herein disclosed is intended to be limited only by the scope of the appended claims.

I claim:

1. A deformable resilient footbed for the human foot comprised of foamed ethylene vinyl acetate polymer (“EVA”) as its major ingredient which has an upper sole to be contacted with the sole of its human wearer's foot, which upper sole produces a continuous gentle massaging action on the sole of said foot during any activity on the part of the wearer that involves alternate flexing or bending of the foot by which said foot alternately compresses and then releases said upper sole, wherein said upper sole is configurated in the form of a continuous pattern of undulating waves produced by the action of a machine
(A) which is essentially constructed so that it has two identical metallic rollers which are arranged with one directly above the other, each of which rollers is covered with closely spaced, evenly aligned, rounded metallic protrusions extending around its entire periphery, which rollers are adapted to rotate in countercurrent directions to move a plastic mass forward from a point at which said mass is fed between said rollers, while concurrently acting in concert to apply a pressure of about 1200 kg per sq. cm. on said plastic mass, and also has knife means positioned just behind and between the two rollers, which knife means is (i) adapted to rapidly slice longitudinally, into two separate sheets, a plastic mass as said mass emerges from between said rollers and (ii) is equipped with means for maintaining the sharpness of said knife means at a maximum in periods during which the machine is operating, and the process for producing said footbed comprises the following essential steps:
(1) preparing a mixture of preformed EVA polymer with foaming agents and foam stabilizing agents;
(2) subjecting the mixture from step 1 to the action of at least one machine capable of blow molding said mixture into thin essentially rectangular shaped sheets and then passing these sheets to a machine in which these thin EVA polymer sheets are permitted to foam, whereby they expand substantially in all their dimensions, under the influence of a temperature of 170°-180° C., and at least 800 kg./sq. in. of pressure, removing the so expanded pieces and allowing them to cool in air, followed by cutting them into slabs each approximately 55-65 centimeters thick and otherwise sized for being processed in the machine described in part (A) hereof,
(3) feeding each slab from step 2 into the machine described in part (A) hereof and between its two identical rollers, which have been caused to commence rotating in countercurrent directions with the upper roller rotating counterclockwise and the lower one rotating clockwise,
(4) allowing each said slab from step 3 hereof to be forwarded through the action of said rollers to exit from contact with them and to immediately contact said knife means as said slab begins to exit from between said rollers, whereby said knife means swiftly splits said slab as the slab longitudinally proceeds out from between said rollers into two sheets of approximately equal thickness, wherein the lower one of said sheets exhibits said continuous pattern of undulating waves on its upper surface and the upper one of said sheets exhibits the same pattern on its bottom surface, with the bottom of the lower sheet and the top of the upper sheet being essentially flat,
(5) allowing said two sheets produced in step 4 hereof to rest,
(6) placing said two sheets from step 5 into an abutting relationship on their respective flat sides,
(7) forwarding said two sheets with flat sides in abutting relationship into a further machine wherein one or more pre-sized cutting molds for either a left or a right shoe sole are placed on the top side of said two sheets with flat sides abutting and said further machine causes said pre-sized cutting molds to cut through both sheets to produce one pair of left and right footbeds for each of the single left or right pre-sized cutting molds on the top side; and
(8) recovering from the cut sheets produced in the preceding step each pair of pre-sized footbeds produced in step 7 hereof.

2. A deformable resilient footbed according to claim 1 which has been converted into a sandal by the further steps of
(a) dipping said footbed into a liquid resinous coating composition containing a colored pigment;
(b) passing said coated footbed from step (a) through a drying step to produce a color-coated footbed with a smooth glossy appearance,
(c) passing said color coated footbed from step (b) into an area wherein it is equipped with any desired upper sole fittings requisite to holding a sandal on the human foot, and, if desired affixing to the bottom of said footbed, a protective under sole, thus creating a sandal.

3. A footbed according to claim 1 in which step 2 is effected by first subjecting the mixture from step 1 to the action of a blow molding machine wherein generally rectangular thin sheets are produced, followed by passing said sheets into a forming machine held at a temperature of 170°-180° C. and a pressure of at least 800 kg./sq. in., wherein each sheet expands substantially in all its dimensions, removing the so expanded sheets and allowing them to cool in air followed by cutting as stated in claim 1.

4. A footbed according to claim 1 for which the formulation for ethylene vinyl acetate (“EVA”) foam is made up in 75,000 gram batches and each batch thereof contains 43,400 grams of preformed EVA polymer, 800 grams of zinc oxide, 300 grams of stearic acid, 500 grams of dicumyl peroxide, 23,000 grams of calcium carbonate, 6,000 grams of azodicarbonate and 1,000 grams of a pigment.

5. An article of footwear in the form of a shoe, a boot or a slipper, whether for general purpose or special purpose wear, that includes the footbed of claim 1.
